(19) United States
(12) Patent Application Publication
(10) Pub. No.: US 2014/0321556 A1
(43) Pub. Date: Oct. 30, 2014

(54) REDUCING AMOUNT OF DATA IN VIDEO ENCODING

(71) Applicants: Shiyuan Xiao, Shanghai (CN); Andreas Ljunggren, Vallingby (SE); Fredrik Romehed, Solna (SE); Yicheng Wu, Shanghai (CN)

(72) Inventors: Shiyuan Xiao, Shanghai (CN); Andreas Ljunggren, Vallingby (SE); Fredrik Romehed, Solna (SE); Yicheng Wu, Shanghai (CN)

(73) Assignee: Telefonaktiebolaget L M Ericsson (publ), Stockholm (SE)

(21) Appl. No.: 14/356,849

(22) PCT Filed: Nov. 16, 2011
(86) PCT No.: PCT/CN2011/001915

§ 371 Date: May 7, 2014

(51) Int. Cl. H04N 19/14; H04N 19/179; H04N 19/70; H04N 19/115

(52) U.S. Cl. CPC H04N 19/00157; H04N 19/0006; H04N 19/0029; H04N 19/00884
USPC 375/240.26

(57) ABSTRACT

A method for encoding screen outputs of an application to a series of video sequences, in which each video sequence can comprise an intra-frame (I-frame) and inter-frames (P-frames) relating to the I-frame, and each video sequence is formed for one screen output. The method can comprise forming a first video sequence for a first screen output, wherein the first video sequence can include an I-frame and (p-frames), and forming a second video sequence including an I-frame and (P-frames) for a second screen output, wherein the I-frame of the second video sequence can be obtained by encoding a changed area of the second screen output compared to the first screen output. A device for encoding, encoder, a device for decoding, and a decoding are also provided. The video data can be reduced according to the present invention.

### TECHNICAL FIELD

The invention relates to processing of multimedia data, in particular, to reducing amount of data in encoding the screen outputs of an application.

### BACKGROUND

On demand services refer to those services which are directly streamed to an end-user by means of the network connection, servers, related compression technical, and the like, upon the demand. The contents of the services are not stored on the end-user's machine, such as computer, mobile phone, etc., but on the servers. The servers encode the contents and transmit the encoded one to the end-user's machine such that the end-user experiences the service without installing any application relating to the services in his/her machine.

On demand services becomes more and more popular with highly development of the network technology, including the fixed network, mobile communication network, and other network used to transmitting data among devices.

Gaming on Demand (GoD) is one example of on demand services. The user can play the game, which is installed in the server, using user equipment (i.e., the user's machine above mentioned) which is connected to the server via the network. Other examples of on demand services involve the Video on Demand (VOD), television on Demand (TOD), and so on.

The server encodes the contents of the application relating to the on demand services, for example the contents of game, in order to form a compressed data to facilitate the transmission over the network.

Smooth transmission over the network without network latency brings the user who expects to enjoy the on demand service good experience. However, when traffic of the network is beyond a certain threshold, the network latency occurs due to network congestion and causes the on demand services to be a bad experience for the user.

### SUMMARY OF THE INVENTION

In view of the foregoing, it is an object of this invention to provide a method, device, and encoder that allows the amount of video data to be encoded is reduced such that above mentioned and other problems can be addressed.

The present invention provides a method for encoding screen outputs of an application to a series of video sequences, in which each video sequence can comprise an intra-frame (I-frame) and inter-frames (P-frames) relating to the I-frame. The screen outputs of the application can be input to a device used to encode it and stored in a memory of that device. Each video sequence according to one aspect of the present invention can be formed for each screen output. The method can comprise forming a first video sequence for a first screen output, wherein the first video sequence can include an I-frame and p-frames, and forming a second video sequence including an I-frame and P-frames for a second screen output, wherein the I-frame of the second video sequence can be obtained by encoding a changed area of the second screen output compared to the first screen output.

The present invention further provides an encoder for encoding screen outputs of an application to a plurality of video sequences, in which each video sequence comprises an intra-frame (I-frame) and inter-frames (P-frames) relating to the I-frame, and each video sequence is formed for one screen output. The encoder is arranged to form a first video sequence comprising an I-frame and p-frames for a first screen output, and to form a second video sequence including an I-frame and P-frames for a second screen output, in which the I-frame of the second video sequence is obtained by encoding a changed area of the second screen output compared to the first screen output.

The present invention further provides an device used for encoding screen outputs of an application to a series of video sequences, where each video sequence is formed for one screen output and each video sequence comprises an intra-frame (I-frame) and inter-frames (P-frames) relating to the I-frame. The device can include a storage and an encoding element, in which the storage can be used to store the screen outputs of an application as raw data and the encoding element can be used to form a first video sequence comprising an I-frame and p-frames for a first screen output, and form a second video sequence including an I-frame and P-frames for a second screen output, wherein the I-frame of the second video sequence can be obtained by encoding a changed area of the second screen output compared to the screen output.

The present invention also provides a method for decoding a series of video sequences, where each video sequence comprise an intra-frame (I-frame) and inter-frames (P-frames) relating to the I-frame and each video sequence is formed for a screen output of a plurality of screen outputs of an application. The method can comprise decoding a first video sequence comprising an I-frame and p-frames, in which the first video sequence is formed for a first screen output, and decoding a second video sequence comprising an I-frame and p-frames, in which the second video sequence is formed for a second screen output and, wherein the I-frame of the second video sequence is obtained by encoding a changed area of the second screen output compared to the screen output.

The present invention additionally provides a decoder used for decoding a series of video sequences, each video sequence comprising an intra-frame (I-frame) and inter-frames (P-frames) relating to the I-frame, each video sequence being formed for a screen output of a plurality of screen outputs of an application. The decoder can be arranged to decode a first video sequence formed for a first screen output and comprising an I-frame and p-frames, and to decode a second video sequence formed for a second screen output and comprising a I-frame and P-frames, in which the I-frame of the second video sequence is obtained by encoding a changed area of the second screen output compared to the first screen output.

The present invention also provides a device used for decoding a series of video sequences each of which comprising an intra-frame (I-frame) and inter-frames (P-frames) relating to the I-frame, each video sequence being formed for a screen output of a plurality of screen outputs of an application. The device can comprise a storage and a decoding element, in which the storage can be used for storing the received video sequences and the decoding element can be used for decoding a first video sequence formed for a first screen output and comprising an I-frame and p-frames, and used for decoding a second video sequence formed for a second screen output and comprising an I-frame and p-frames, in which the I-frame of the second video sequence is obtained by encoding a changed area of the second screen output compared to the first screen output.

The location information for the changed area can be included in the I-frame of the second video sequence.

According to the present invention, the amount of video data in the I-frame of video sequence can be reduced.

### BRIEF DESCRIPTION OF THE DRAWINGS

In the following, the invention will be described in details with reference to an example and the appended drawings, wherein,

FIG. 1 is a graphic, showing the average network bandwidth VS amount of data of each frame of a video sequence.

FIG. 2 is a flow chart of a method for encoding screen outputs of an application to a series of video sequences according to an embodiment of the present invention.

FIG. 3 illustrates an exemplary structure of RTP (Real Time Protocol) packet of I frame according to an embodiment of the present invention.

FIG. 4 illustrates an exemplary structure of extended data shown in FIG. 3.

FIG. 5a illustrates an exemplary display of the first video sequence.

FIG. 5b illustrates a display next to the first video sequence shown in FIG. 5a.

FIG. 6 illustrates a block diagram of a device used for encoding screen outputs of an application to a series of video sequences, according to the present invention.

FIG. 7 is a flowchart of the method for decoding a series of encoded video sequences, according to an embodiment of the present invention.

FIG. 8 illustrates a block diagram of a device used for decoding a series of video frames, according to an embodiment of the present invention.

FIG. 9 illustrates an example of one screen output of an application.

FIG. 10 illustrates an exemplary architecture of cloud computing in accordance with the present invention.

### DETAILED DESCRIPTION

The present invention will be described more fully with reference to the accompanying drawings, in which various embodiments are shown. This invention may, however, be embodied in many different forms and should not be constructed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “comprising”, “including”, and variants thereof, when used in this specification, specify the presence of stated features, steps, elements, and/or components, but do not preclude the presence or addition of one or more other features, steps, elements, components, and/or groups thereof.

It will be understood that, although the terms “first”, “second” may be used herein to describe various video sequences, elements, and so on, these video sequences and elements should not be limited by these terms. These terms are only used to distinguish one video sequence and element discussed herein from another. Thus, a first video sequence or a first element discussed below could be termed a second video sequence or a second element without departing from the teachings of the present invention.

Unless otherwise defined, all terms (including technical and scientific terms) used herein have the same meaning as commonly understood by one of ordinary skilled in the art to which this invention belongs.

The video files in multimedia files comprise a great number of still image frames, which are displayed rapidly in succession (of typically 15 to 30 frames per second) to create an impression of a moving image. The image frames typically comprise a number of stationary background objects, determined by image information which remains substantially unchanged, and few moving objects, determined by image information that changes to some extent. The information comprised by consecutively displayed image frames is typically largely similar, i.e. successive image frames comprise a considerable amount of redundancy. The redundancy appearing in video files can be divided into spatial, temporal and spectral redundancy. Spatial redundancy refers to the mutual correlation of adjacent image pixels, temporal redundancy refers to the changes taking place in specific image objects in subsequent frames, and spectral redundancy to the correlation of different color components within an image frame.

To reduce the amount of data in video files, the image data can be compressed into a smaller form by reducing the amount of redundant information in the image frames. In addition, while encoding, most of the currently used video encoders downgrade image quality in image frame sections that are less important in the video information. Further, many video coding methods allow redundancy in a bit stream coded from image data to be reduced by efficient, lossless coding of compression parameters known as VLC (Variable Length Coding).

In addition, many video coding methods make use of the above-described temporal redundancy of successive image frames. In that case a method known as motion-compensated temporal prediction is used, i.e. the contents of some (typically most) of the image frames in a video sequence are predicted from other frames in the sequence by tracking changes in specific objects or areas in successive image frames. A video sequence always comprises some compressed image frames the image information of which has not been determined using motion-compensated temporal prediction. Such frames are called INTRA-frames, or I-frames. Correspondingly, motion-compensated video sequence image frames predicted from previous image frames, are called INTER-frames, or P-frames (Predicted). The image information of P-frames is determined using one I-frame and possibly one or more previously coded P-frames.

An I-frame typically initiates a video sequence defined as a Group of Pictures (GOP), the P-frames of which can only be determined on the basis of the I-frame and the previous P-frames of the GOP in question. The next I-frame begins a new group of pictures GOP, i.e. a new video sequence. The P-frames of new GOP can only be determined on the basis of the I-frame of the new GOP. Such coding method used to reduce redundancy in video images is applied in certain of standards issued by the ITU-T (International Telecommunications Union, Telecommunications Standardization Sector), such as H.264, MPEG-4 and so on. However, the amount of video data of I-frame is still relative large when the method is applied to some standards, such as H.264 and MPEG-4.

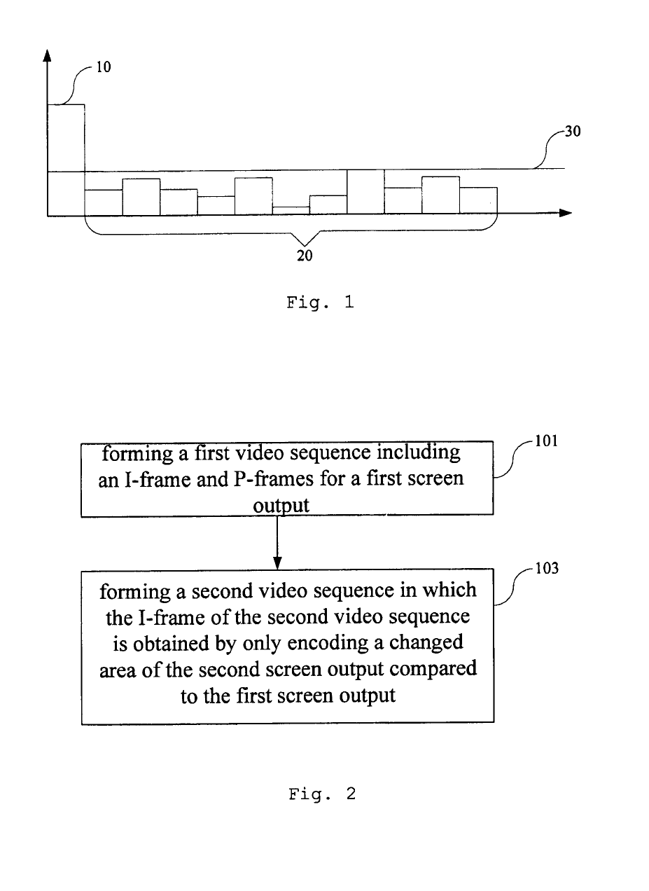

FIG. 1 is a graphic, showing the average network bandwidth VS amount of data of each frame of a video sequence. The video sequence shown in FIG. 1 is one of a series of video sequences of a game which is encoded by MPEG-4. As shown, the video sequence which can be referred to as GOP starts with I-frame 10 and a necessary number of P-frames 20. As shown, the amount of data of I-frame 10 is much more than the average throughout 30 of the network. The large amount of the video data blocks smooth transmission of I-frame 10 over the network, such that the I-frame can not be received and decoded in real time by a receiver which can be provided with an electronic device such as mobile phone. In practice, a jitter buffer is provided for a decoder of the conventional receiver to ensure that the whole I-frame can be received prior to decoding it.

FIG. 2 is a flow chart of a method for encoding screen outputs of an application to a series of video sequences according to an embodiment of the present invention. The screen outputs of the application herein refer to raw data input to a device and stored in a memory of that device, where the device is used to encode the screen outputs to a series of video sequences. The encoded series of video sequences can be displayed in a user equipment, such as mobile phone, MP3, MP4, laptop and the like, which can be connected to the device via a network. Each video sequence beginning with an I-frame and further including a necessary number of P-frames is formed for a screen output of the application.

As shown, a first video sequence is formed (step 101) for a first screen output, which includes an I-frame and a necessary number of P-frames. The P-frames of the first video sequence are determined on the basis of the I-frame and/or the previous P-frames. Then, a second video sequence is formed (step 103) for a second screen output, in which the I-frame of the second video sequence is obtained by only encoding a changed area of second screen output compared to the first screen output. It can be understood that the second screen output is displayed to the user later than the first screen output.

In order for the user equipment in displaying the application to know the particular location of the changed area with respect of the whole screen output, the location information of the changed area is included in the I-frame of the second video frame as an extended data.

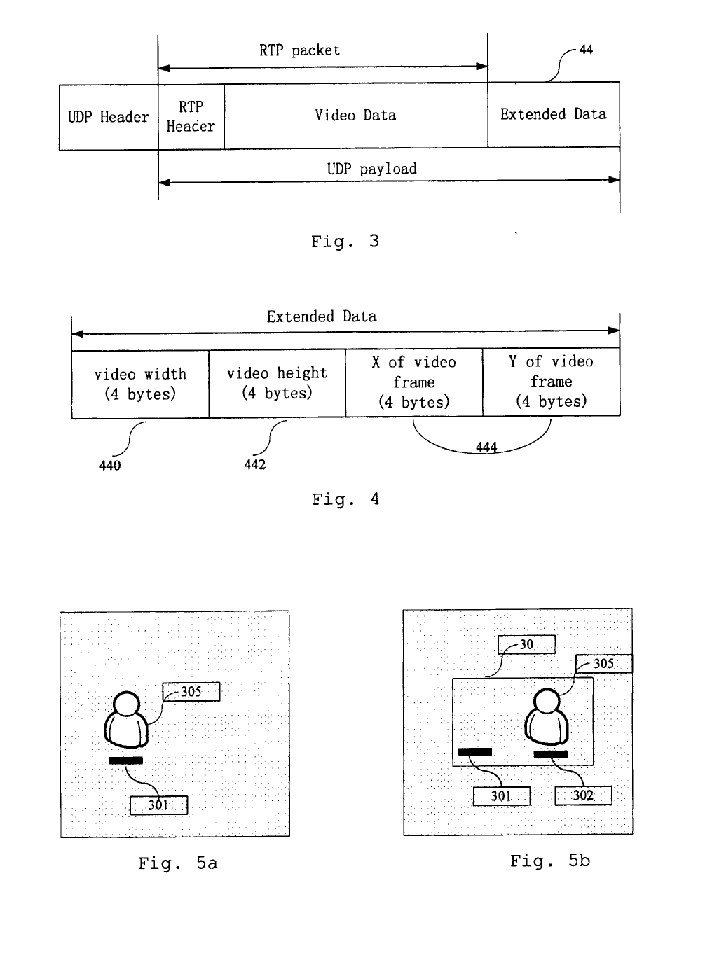

Byway of example, the method according to one embodiment of the present invention, the video sequences are encoded by using H.264 or MPEG-4. FIG. 3 illustrates an exemplary structure of RTP (Real Time Protocol) packet of I frame according to an embodiment of the present invention. FIG. 4 illustrates an exemplary structure of extended data shown in FIG. 3. As shown in FIG. 3, the RTP packet of I frame includes an extended data part which indicates the location information of the changed area. The other parts of the RTP packet, such as UDP (User Datagram Protocol) header, RTP header and so on, are defined by RFC 3984 (RTP Payload Format for H.264 Video) and RFC 3016 (RTP Payload Format for MPEG-4 Video/Visual Streams). Referring to FIG. 4, the extended data includes video width part 440 showing value of the width of the changed area, video height 442 showing value of the height of the changed area, and the reference point part 444 which locates the changed area with respect to the screen output of the application. According to the present embodiment, the extended data 44 can be appended only to the first RTP packet of the I-frame, and the P-frames following the I-frame can use the extended data in the I-frame without including the location information, i.e., it is not necessary for P-frame to append the extended data either, such that unnecessary network traffic can be avoided. In case that the size of I-frame appended with the extended data is beyond the desired size, the I-frame can be divided into several RTP packets. However, the location information also can be provided with the video sequence in other manners, such as in P-frames. It can be understood that the illustration in FIG. 3 and FIG. 4 is only an illustrative example. Furthermore, according to the present invention, the changed area can be an area which is kept to be changed for a while.

Referring to FIG. 2, it will be understood that the term “first” of the first video sequence” or “the first screen output” is not used to limit that the first video sequence or the first screen output is the real first one of the series of video sequences or the real first screen output. As above mentioned, the term “first” is only used to distinguish one video sequence from another, and distinguish one screen output from another. The first screen output according to the present invention can be the real first screen output of the application, and also can be any one of the screen outputs of the application. Similarly, the first video sequence can be the real first video sequence of the series of video sequences, and also can be any one of the series of the video sequences. For example, the screen outputs of the application can be formed into video sequence 1, video sequence 2, video sequence 3, video sequence 4, video sequence 5, . . . , video sequence n-2, video sequence n-1, and video sequence n. In this case, the first video sequence herein can be employed to indicate any video sequence, such as video sequence 2, or video sequence 5, or video sequence n-2, or the real first video sequence, namely, video sequence 1. In similar, the second screen output is used to refer to any screen output of the applications except the real first video sequence. Correspondingly, the second video sequence can be any video sequence of the series of video sequences except the real first video sequence. For example, the second video sequence can be video sequence 1, such as the video sequence 3, or video sequence 6, or video sequence n-1, or the real second video sequence, namely, video sequence 2.

Further, if the first video sequence is the real first video sequence of the series of the video sequences, the I-frame of the first video sequence is formed by encoding raw data of the first screen output of the application at step 101; and if the first video sequence is not the real first video sequence, for example, the first video sequence is the video sequence 2, video sequence 3, etc., the I-frame of the first video sequence is formed by only encoding the changed area of the corresponding screen output compared to the previous screen output.

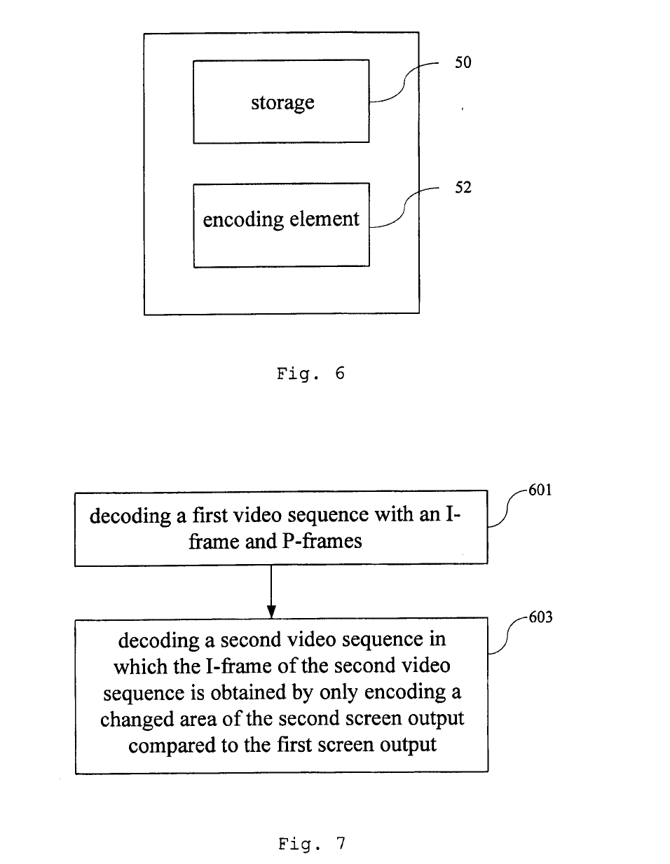

FIG. 5a illustrates an exemplary display of the first video sequence. The display of the first video sequence is the first screen output of the application. It should be noted that FIG. 5a is only illustrative without intention of limiting. In fact, the video sequence displayed after being decoded may include more details than shown. By way of example, the person 305 of the first screen output will move from position 301 to another one. The display of the second video sequence, i.e., the second screen output of the application is shown in FIG. 5b, in which the position to which the person 305 moves is indicated as 302. Compared to the first screen output, only the location of the person 305 is changed. Therefore, the area 30 including at least the persons original positions 301, and the new position 302 can be considered as a changed area. In this case, the I-frame of the second video sequence is formed by only encoding the changed area 30. During encoding, the location information for this changed area 30 is also included in the I-frame of the second video sequence. As only the changed area 30 is encoded, the amount of video data of I-frame of the second sequence is much less than that of the whole screen output is encoded. Return to FIG. 1, the amount of data of the I-frame exceeds the average throughout 30 of the network is reduced, even below the average throughout of the network. The network latency resulted from the big I-frame is improved a lot.

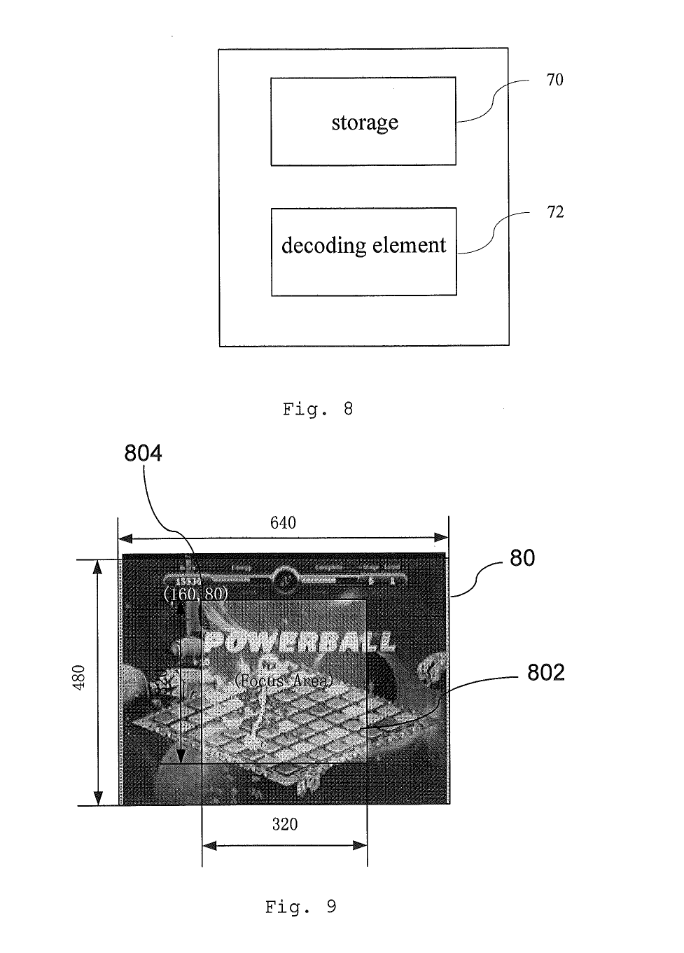

FIG. 6 illustrates a block diagram of a device used for encoding the screen outputs of an application to a series of video sequences, according to the present invention. The device includes storage 50 and an encoding element 52. The storage 50 stores the screen outputs of the application as raw data which can be used to form video sequence. The storage 50 can be used to store other related data. The encoding element 52 encodes the screen outputs of the application to a series of video sequences, in which each video sequence is formed for a screen output and each video sequence includes an I-frame and a necessary number of P-frames. The necessary number of P-frame herein refers to one or more P-frames which are needed in forming the video sequence. A first video sequence is formed for a first screen output by the encoding element 52, where the first video sequence comprises an I-frame and P-frames. As above discussed with reference to FIG. 2, the first screen output and the first video sequence can be the real first screen output of the applications and the real first video sequence of the series of video sequences, respectively, in this case, the I-frame of the first video sequence can be formed by encoding the raw data of the first screen output, in which the raw data can be inputted to the device and stored in the storage 50. However, if the first video sequence is not the real first video sequence of the series of video sequences, such as the video sequence 3, or video sequence 5 and so on, the I-frame of the first video sequence is formed by only encoding the changed area of the first screen output compared to a previous screen output, such as the screen output corresponds to the video sequence 2. The second video sequence is also encoded by the encoding element 52. The element encoding element 52 forms the second video sequence by forming the I-frame by means of only encoding the changed area of the second screen output compared to the first screen output and then forming a necessary P-frames on the basis of the formed I-frame. The video data produced by the device during encoding the screen outputs of the application is reduced since the encoding element 52 only encodes the changed area. In order for a device receiving and decoding the encoded video sequence to know the position of the changed area with respect to the I-frame of the first video sequence, the location information for the changed area is included in the I-frame of the second video sequence. For example, the location information can be provided with the I-frame as shown in FIG. 3 and FIG. 4. The device illustrated in FIG. 6 can be embodied as a computer, portable device, such as a mobile phone, media player, and the like. It shall be understood that the device can further include input and output element, processor, and so on. In case of the device includes the processor, the encoding element can be optionally integrated into it.

The encoding element 52 of the device shown in FIG. 6 can be embodied to be a separate element which can be provided within various apparatus, such as computer, portable device, such as mobile phone, and the like. The separate element can be further embodied as encoder, which is arranged to encode the screen outputs of the applications as the method discussed with reference to FIG. 2. The encoder according to the present invention can be achieved by software, hardware, or the both. The encoder herein can include the elements which are included by the conventional encoder, with one except that the encoder of the present invention is arranged to form the I-frame of one video sequence by encoding the changed area of corresponding screen output compared to a previous screen output. In one embodiment of the present invention, the encoder is a H.264 encoder or Mpeg-4 encoder.

FIG. 7 is a flow chart of the method for decoding a series of encoded video sequences, according to an embodiment of the present invention. Each video sequence includes an I-frame and P-frames relating to the I-frame, and each video sequence is formed for a screen output of a plurality of screen outputs of an application. As shown, at step 601, a first video sequence is decoded, in which the first video sequence is formed for a first screen output and includes an I-frame and a necessary number of P-frames. At step 603, a second video sequence is decoded in which the second video sequence is formed for a second screen output and includes an I-frame and p-frames, where the I-frame is formed by only encoding the changed area of the second screen output compared to the first screen output. The location information for the changed area with respect to the whole screen output is included in the second video sequence so as to determine the location information of the changed area. As an example, the location information can be included in the I-frame in a manner discussed with reference to FIG. 3 and FIG. 4. Therefore the particular location of the changed area can be obtained during decoding the I-frame of the second video sequence, such that the video image associated with the second video sequence can be properly reproduced. The first video sequence can be the real first video sequence of the series of video sequences as above discussed with reference to FIG. 2, in that case, the I-frame of the first video sequence can be formed by encoding the raw data of first video screen output. However, if the first video sequence is not the real first video sequence of the series of video sequences, such as the video sequence 3, or video sequence 5 and so on, the I-frame of the first video sequence is formed by only encoding the changed area of the corresponding screen output compared to a previous screen output, such as video sequence 2, or video sequence 4 and so on.

Any apparatus, such as user equipment, which performs the method for decoding the series of encoded video sequences according to the present invention can decode the video sequences with less time and less overhead for I-frames of most of video sequences have much less amount of data. The apparatus only updates the part of the screen output of its display which is related to the changed area in displaying the decoded video sequences.

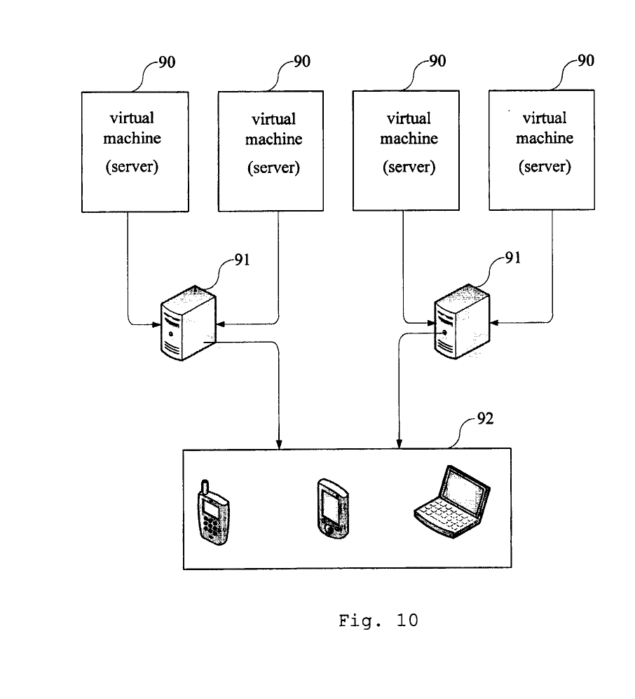

FIG. 8 illustrates a block diagram of a device used for decoding a series of video sequences, according to an embodiment of the present invention. The video sequences are formed for screen outputs of an application, in which each video sequence is formed for a screen output. The device includes storage 70 and a decoding element 72. The storage 70 is used for storing received video sequences. The received video sequence is temporarily stored in the storage 70 before being decoded. The decoding element 72 decodes a first video sequence formed for a first screen output and including an I-frame and P-frames. The decoding element 72 further decodes a second video sequence. The second video sequence is formed for a second screen output and comprises an I-frame and P-frames, in which the I-frame of the second video sequence is obtained by encoding a changed area of the second screen output compared to the first screen output. The location information for the changed area is encoded in the second video sequence such that the device knows the particular position of the changed area with respect to the screen output. Therefore the particular location of the changed area can be obtained during decoding the I-frame of the second video sequence, such that the video image associated with the second video sequence can be properly reproduced. Further, the device can include a display for displaying the decoded video sequences. The device shown in FIG. 8 can be embodied as a computer, a portable device, such as mobile phone, the media player, and the like. It shall be understood that the device can further include input and output element, processor, and so on. In case of the device includes the processor, the decoding element can be optionally integrated into it.

The decoding element 72 of the device shown in FIG. 8 can be embodied to be a separate element which can be provided within various apparatus, such as computer, portable device, such as mobile phone, MP3, MP4, and the like. The separate element can be further embodied as decoder, which is arranged to decode the screen outputs of the application as the method discussed with reference to FIG. 8. The decoder according to the present invention can be achieved by software, hardware, or the both.

The device used for decoding a series of video frames of the present invention or the apparatus which is provided with the decoder according to the present invention can decode the video sequences with less time and less overhead because the I-frames of most of video sequences have much less amount of data.

Generally, video sequences can be obtained by only encoding the changed area of a screen output according to the present invention. Because the changed area is smaller than the whole screen output mostly, with one except that the changed area is the whole screen output, the encoded video sequence, especially the I-frame of the video sequence has much less amount of video data. The application's screen outputs keep changing, that is, the changed area is not fixed, but varying. However, the method, the device, and the encoder of the present invention can obtain the changed area for example from the application itself, namely, the application, such as the games, substantially knows the changed area in future. Further, the method, the device, and the encoder of the present invention can obtain the changed area by interacting with the user.

The application as above described can be game, movie, and other application that can be shown to the user in a video manner. According to the present invention, the application is encoded into a series of video sequences and decoded as above discussed.

The methods, devices, encoder, and decoder can be used separately or in combined each other. For example, the methods according to the present invention can be used separately in a system, such as on-demand services providing system, which includes one or more servers connected to the user equipment via network, for example telecommunication network, such as 2.5G, 3G, and 4G, and internet, local network, and the like. In such system, the method for coding applications with reference to FIG. 2 can be applied to the server according to one embodiment of the present invention. The encoded video sequences in such system have much less amount of data for I-frame of each video sequence such that it is possible that the network of certain throughout transmits the video sequences with less latency, even no latency. Furthermore, the server in such streaming system can be the device discussed referring to FIG. 6, or can be configured with the encoder discussed above. The user equipment receives the video sequences from the server of the on-demand system, and further decodes the received video sequences in the manner discussed with reference to FIG. 7. Moreover, the user equipment can be the device shown in FIG. 8, or can be configured with the decoder as above discussed. Actually, with only encoding the changed area, the data required to be decoded is also relatively low, thereby the time in decoding and the overhead of the device in decoding the encoded video sequence is reduced.

Referring to FIG. 9, showing an example of one screen output of an application. The application in this example is a game which can be an on-demand game. The screen output is an image which can be shown on a display. The screen output 80 as shown has a length of 640 pixels and a height of 480 pixels. A focus area 802 is the area which keeps changing for a while according to the game, where the length and height of the focus area 802 are 320 and 320 pixels, respectively. The reference point of the focus area relative to the whole screen output 80 is denoted by 804 with coordinate (160, 80). According to an embodiment of the present invention, the whole screen output 80 (i.e., the video image) is first encoded as a video sequence and transmitted to the user equipment. Then, only the focus area 802 is encoded as the next video sequence to be transmitted. The location information of the focus area 801 including the coordinate of the reference point 804, the value of the width, and the value of the height is provided within the I-frame of the next video sequences, for example in the first RTP packet of the I-frame as shown in FIG. 3 and FIG. 4.

The method, device and encoder used to encode a screen output of an application, such as game, movie, and other any application for which the video encoding is required, can be applied to any place where the video encoding are needed. Correspondingly, the method, device and decoder can be applied to the place where the received video sequences are formed for example according to the present invention. Such place can be IPTV system, above mentioned on-demand services providing system, and so on. In IPTV system, the server can encode the screen output of the application, namely the program of television, with the method as above discussed with reference to FIG. 2. Alternatively, the server can be a device as discussed with reference to FIG. 6, or the server can be configured with the encoder as above discussed. The encoded video sequences are transmitted to the user equipment. The device receiving the encoded video sequence, such as TV, computer, portable device, such as the mobile phone, the media player, and the like, can decode the received video sequences as discussed with reference to FIG. 7. Alternatively, the device receiving and decoding the encoded video sequence can be such kind of device described with reference to FIG. 8, or can be provided with the decoder as above mentioned.

Further, the methods, devices, encoder, and decoder can also be applied to a streaming system. The term “streaming” refers to simultaneous sending and playback of data, typically multimedia data, such as audio and video data, in which the recipient may begin data playback already before all the data to be transmitted are received. Multimedia data streaming systems comprise a streaming server and user equipment which the recipients use for setting up a data connection, such as via a telecommunications network, to the streaming server. From the streaming server the recipients retrieve either stored or real-time multimedia data, and the playback of the multimedia data can then begin, most advantageously almost in real-time with the transmission of the data, by means of a streaming application included in the user equipment. The system providing On-demand services can be regarded as one type of streaming system.

FIG. 10 illustrates an exemplary architecture of cloud computing in accordance with the present invention. The user equipment 92, such as mobile phone, personal computer, television, and tablet personal computer, can request on demand service via the application on demand center 91. Assuming that the requested on demand service is game on demand, the application on demand center 91 find the application on demand server 90, a virtual machine, which can provide the game, then sends the request from the user equipment 92 to the found server 90. The server 90 encodes the game with the method as above discussed with reference to FIG. 2. Alternatively, the server 90 can be a device as discussed with reference to FIG. 6, or the server 90 is configured with the encoder as above discussed. The encoded video sequences of the game are transmitted to the user equipment 92 via network. The user equipment 92 can decode the encoded video sequences as discussed with reference to FIG. 7. Alternatively, the user equipment 92 can be such kind of device described with reference to FIG. 8, or can include the decoder as above mentioned.

According to the present invention, only the changed area of the screen output is encoded, the amount of video data of I-frame is reduced and even the amount of data of P-frame which is obtained on the basis of I-frame is also reduced. With reduced video data, it is possible for latency resulted from the transmission of network to be avoided. Further, the device receiving the encoded video sequences can decode the video sequences with lower overhead.

Although the foregoing invention has been described in some details for purpose of clarity of understanding, it will be apparent that certain changes and modifications may be practiced within the scope of the appended claims. Therefore, the embodiments herein should be taken as illustrative and not restrictive, and the invention should not be limited to the details given herein but should be defined by the appended claims and their full scope of equivalents.

1. A method for encoding screen outputs of an application which are raw data input and stored in a memory to a series of video sequences, each of the video sequences being formed for a screen output, each of the video sequences comprising an intra-frame (I-frame) and inter-frames (P-frames) relating to the I-frame, the method comprising:
forming a first video sequence for a first screen output, wherein the first video sequence comprises an I-frame and p-frames, and
forming a second video sequence including an I-frame and P-frames for a second screen output, wherein the I-frame of the second video sequence is obtained by encoding a changed area of the second screen output compared to the first screen output.

2. The method according to claim 1, wherein location information of the changed area is included in the I-frame of the second video sequence.

3. The method according to claim 1, wherein encoding screen outputs of the application to a plurality of video sequences comprises encoding the screen outputs of the application to a series of video sequences by using H.264 or MPEG-4 standard.

4. An encoder used for encoding screen outputs of an application to a plurality of video sequences, each of the video sequences being formed for a screen output, each of the video sequences comprising an intra-frame (I-frame) and inter-frames (P-frames) relating to the I-frame, wherein the encoder is arranged to form a first video sequence comprising an I-frame and p-frames for a first screen output, and to form a second video sequence including an I-frame and P-frames for a second screen output, in which the I-frame of the second video sequence is obtained by encoding a changed area of the second screen output compared to the first screen output.

5. The encoder according to claim 4, further being arranged to include location information of the changed area in the I-frame of the second video sequence.

6. The encoder according to claim 3, wherein the encoder is an encoder based on H.264 or MPEG-4 standard.

7. An device used for encoding screen outputs of an application to a series of video sequences, each of the video sequences being formed for a screen output, each of the video sequences comprising an intra-frame (I-frame) and inter-frames (P-frames) relating to the I-frame, the device comprising:
a storage device used that stores the screen outputs of an application as raw data, and
an encoding device that forms a first video sequence comprising an I-frame and p-frames for a first screen output, and that forms a second video sequence including an I-frame and P-frames for a second screen output, wherein the I-frame of the second video sequence is obtained by encoding a changed area of the second screen output compared to the first screen output.

8. The device according to claim 7, wherein the encoding device includes location information of the changed area in the I-frame of the second video sequence.

9. The device according to claim 7, wherein the encoding device encodes the screen outputs of the application to a series of video sequences by using H.264 or MPEG-4 standard.

10. A method for decoding a series of video sequences, each of the video sequences comprising an intra-frame (I-frame) and inter-frames (P-frames) relating to the I-frame, each of the video sequences being formed for a screen output of a plurality of screen outputs of an application, the method comprising:
decoding a first video sequence comprising an I-frame and p-frames, in which the first video sequence is formed for a first screen output, and
decoding a second video sequence comprising an I-frame and p-frames, in which the second video sequence is formed for a second screen output and the I-frame of the second video sequence is obtained by encoding a changed area of the second screen output compared to the first screen output.

11. The method according to claim 10, wherein location information of the changed area is obtained from the I-frame of the second video sequence in decoding the second video sequence.

12. The method according to claim 10, wherein the series of video sequences are decoding with H.264 or MPEG-4 standard.

13. A decoder used for decoding a series of video sequences, each of the video sequences comprising an intra-frame (I-frame) and inter-frames (P-frames) relating to the I-frame, each of the video sequences being formed for a screen output of a plurality of screen outputs of an application, wherein the decoder is arranged to decode a first video sequence formed for a first screen output and comprising an I-frame and p-frames, and to decode a second video sequence formed for a second screen output and comprising a I-frame and P-frames, in which the I-frame of the second video sequence is obtained by encoding a changed area of the second screen output compared to the first screen output.

14. The decoder according to claim 13, further being arranged to obtain location information of the changed area from the I-frame of the second video sequence in decoding the second video sequence.

15. The decoder according to claim 13, wherein the decoder is an encoder based on H.264 or MPEG-4 standard.

16. A device used for decoding a series of video sequences each of which comprising an intra-frame (I-frame) and inter-frames (P-frames) relating to the I-frame, each of the video sequences being formed for a screen output of a plurality of screen outputs of an application, the device comprising:
a storage used for storing received video sequences, and
a decoding element used for decoding a first video sequence formed for a first screen output and comprising an I-frame and p-frames, and used for decoding a second video sequence formed for a second screen output and comprising an I-frame and p-frames, in which the I-frame of the second video sequence is obtained by encoding a changed area of the second screen output compared to the first screen output.

17. The device according to claim 16, wherein the decoding element obtains location information of the changed area by the I-frame of the second video sequence in decoding the second video sequence.

18. The device according to claim 16, wherein the decoding element decodes the plurality of video sequences with H.264 or MPEG-4 standard.

19. The device according to claim 16, further including a display connected to receive and display the decoded video sequences.
